(19) United States
(12) Patent Application Publication
(10) Pub. No.: US 2026/0220145 A1
(43) Pub. Date: Jul. 30, 2026

(54) METHODS FOR PROVIDING A PROPERTY COLLABORATION TOOL AND DEVICES THEREOF

(71) Applicant: Jones Lang LaSalle IP, Inc., Chicago, IL (US)

(72) Inventors: Sulabh Bhanti, Singapore (SG); Benny Foo, Singapore (SG); Amit Sharma, Bengaluru (IN); Govindaraj Praveen Kumar, Singapore (SG)

(21) Appl. No.: 19/040,466

(22) Filed: Jan. 29, 2025

(51) Int. Cl. G06F 16/248; G06F 9/451; G06F 21/62

(52) U.S. Cl. CPC G06F 16/248; G06F 9/451; G06F 21/62; G06F 2221/2113; G06F 2221/2141

(57) ABSTRACT

A method, system, and non-transitory computer readable medium includes providing, by a computing device to a client device, a graphical user interface with input fields to receive property data. The graphical user interface can be generated prior to providing the graphical user interface to the client device. The method can further include storing, by the computing device, an asset record in a NoSQL database. The asset record can be generated and can comprise property attributes based on the property data received from the client device via the input fields. The records in the NoSQL database can have a dynamic schema. Then, the method can include updating and providing, by the computing device, a modified graphical user interface to the client device. The modified graphical user interface can comprise a set of records from the NoSQL database.

### FIELD

This technology generally relates to generating a digital property asset and, more particularly, to methods for generating and managing a digital property asset and devices thereof.

### BACKGROUND

Existing conventional tools for managing mixed-use properties are lacking. In particular, these prior tools often require the use of multiple, disjointed digital footprints to manage different aspects of a property, such as retail, office, and residential spaces. This fragmentation leads to inefficiencies and data inconsistencies, as various department may maintain their own records and systems. By the time a comprehensive view of the property is assembled, the data is often outdated, inaccurate, and full of noise of information useless for the user—hindering the ability of the user to make informed decisions. Current tools do not provide an integrated, real-time solution.

A solution that addresses these issues by creating a unified digital asset for each property, which consolidates all relevant data into a single, easily accessible platform is needed.

### SUMMARY

A method that generates a report as a marketing tool by generating hierarchical graphical user interfaces includes providing, by a computing device to a client device, a graphical user interface with input fields to receive property data. The graphical user interface can be generated prior to providing the graphical user interface to the client device. The method can further include storing, by the computing device, an asset record in a NoSQL database. The asset record can be generated and can comprise property attributes based on the property data received from the client device via the input fields. The records in the NoSQL database can have a dynamic schema. Then, the method can include updating and providing, by the computing device, a modified graphical user interface to the client device. The modified graphical user interface can comprise a set of records from the NoSQL database.

A non-transitory computer readable medium having stored thereon instructions comprising machine executable code which when executed by at least one processor, causes the processor to provide, to a client device, a graphical user interface with input fields to receive property data. The graphical user interface can be generated prior to providing the graphical user interface to the client device. Next, the instructions can cause the processor to store an asset record in a NoSQL database. The asset record can be generated and can comprise property attributes based on the property data received from the client device via the input fields. The records in the NoSQL database can have a dynamic schema. Next, the instructions can cause the processor to update and provide a modified graphical user interface to the client device. The modified graphical user interface can comprise a set of records from the NoSQL database.

A digital asset computing system including at least one or more processors and a memory comprising programmed instructions stored thereon, the one or more processors configured to be capable of executing the stored programmed instructions to provide, to a client device, a graphical user interface with input fields to receive property data. The graphical user interface can be generated prior to providing the graphical user interface to the client device. Next, the programmed instructions can cause the one or more processors to store an asset record in a NoSQL database. The asset record can be generated and can comprise property attributes based on the property data received from the client device via the input fields. The records in the NoSQL database can have a dynamic schema. Next, the programmed instructions can cause the one or more processors to update and provide a modified graphical user interface to the client device. The modified graphical user interface can comprise a set of records from the NoSQL database.

This technology offers several advantages, including providing a method, non-transitory computer-readable medium, and apparatus that enable the creation of a unified digital asset management system for buildings, such as mixed-use buildings. The system integrates data into a single digital footprint. A single digital footprint of an asset permits a user to have a comprehensive view of the asset. Combining the digital footprint with management tools also facilitates better management and decision-making for users. This unified approach eliminates the need for multiple digital footprints and reduces data duplication, ensuring that all property owners have access to a unified, accurate digital asset with up-to-date information. This comprehensive and customizable approach to digital asset management has not been previously available, making it a significant advancement in the field.

### BRIEF DESCRIPTION OF THE DRAWINGS

FIG. 1 is a block diagram of an example of an environment with a digital asset computing system configured to generate and manage digital assets;

FIG. 2A is a block diagram illustrating an example of an architecture of a digital asset computing system;

FIG. 2B is a block diagram illustrating an example of an architecture of a database;

FIG. 2C is a block diagram illustrating an example of an architecture of a client device;

FIG. 3 is an exemplary flowchart of an exemplary method of generating and managing digital assets with a digital asset computing system;

FIG. 4 is an exemplary interface generated using the digital asset computing system that allows for the creation of a digital asset with a building name, address, property type, and geographic data based on the address;

FIG. 5 is an exemplary interface generated using the digital asset computing system that allows a user to upload an image or floor plan of the digital asset;

FIG. 6 is an exemplary interface generated using the digital asset computing system that displays the digital asset and allows for the addition of property fields;

FIG. 7 is an exemplary interface generated using the digital asset computing system that allows for the categorization of property fields, that can display property field definition, or can propose a list of field names from existing data;

FIG. 8 is an exemplary interface generated using the digital asset computing system that allows for the configuration of fields by allowing the quick selection of existing property fields, the creation of new property fields (with the configuration of a data type such as text, number, date, currency, area, or other fields known in the art), and associating the new property fields and configuration to a digital asset. In particular, this exemplary interface includes an example section with a section header of ‘general building information’ with associated property fields;

FIG. 9 is an exemplary interface generated using the digital asset computing system that allows for the configuration of fields by allowing the quick selection of existing property fields, the creation of new property fields (with the configuration of a data type such as text, number, date, currency, area, or other fields known in the art), and associating the new property fields and configuration to a digital asset. In particular, this exemplary interface includes an example section with a section header of ‘research segmentation’ with associated property fields;

FIG. 10 is an exemplary interface generated using the digital asset computing system that displays property fields and that allows for the configuration of fields by allowing the quick selection and alteration of existing property fields, the creation of new property fields, and associating the new property fields and configuration to a digital asset.

FIG. 11 is an exemplary interface illustrating an exemplary digital asset using the digital asset computing system with associated property fields;

FIG. 12 is an exemplary interface illustrating an exemplary digital asset using the digital asset computing system with associated property fields;

FIG. 13 is an exemplary interface illustrating an exemplary digital asset using the digital asset computing system with associated property fields;

FIG. 14 is an exemplary interface illustrating an exemplary digital asset using the digital asset computing system with associated property fields where the digital asset is assigned to representatives or users;

FIG. 15 is an exemplary interface illustrating another exemplary digital asset using the digital asset computing system with associated property fields;

FIG. 16 is an exemplary interface illustrating another exemplary digital asset using the digital asset computing system with associated property fields;

FIG. 17 is an exemplary interface illustrating an exemplary dashboard of an exemplary digital asset using the digital asset computing system;

FIG. 18 is an exemplary interface illustrating an exemplary dashboard of an exemplary digital asset and another exemplary digital asset with property types using the digital asset computing system;

FIG. 19 is an exemplary interface illustrating an exemplary dashboard of another exemplary digital asset using the digital asset computing system;

FIG. 20 is an exemplary interface illustrating an exemplary dashboard of an exemplary digital asset and another exemplary digital asset with property types using the digital asset computing system;

FIG. 21 is an exemplary interface illustrating an exemplary representative or user with user properties (such as a role, additional notes, relationship, contact information, etc.) being associated to an exemplary digital asset using the digital asset computing system;

FIG. 22 is an exemplary interface illustrating an exemplary digital asset using the digital asset computing system with associated property fields (in a tabular format);

FIG. 23 is an exemplary interface illustrating another exemplary digital asset using the digital asset computing system with associated property fields (in a tabular format);

FIG. 24 is an exemplary interface illustrating an exemplary digital asset using the digital asset computing system with associated property fields;

FIG. 25 is an exemplary interface generated using the digital asset computing system that displays the digital asset and allows for the addition of property fields; and

FIG. 26 is an exemplary file of an asset record for a NoSQL database generated by the digital asset computing system.

### DETAILED DESCRIPTION

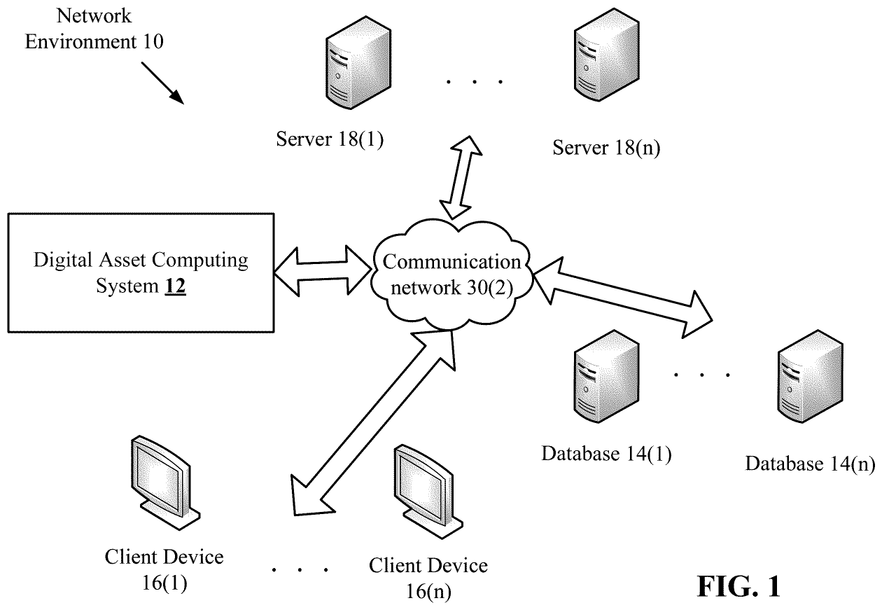

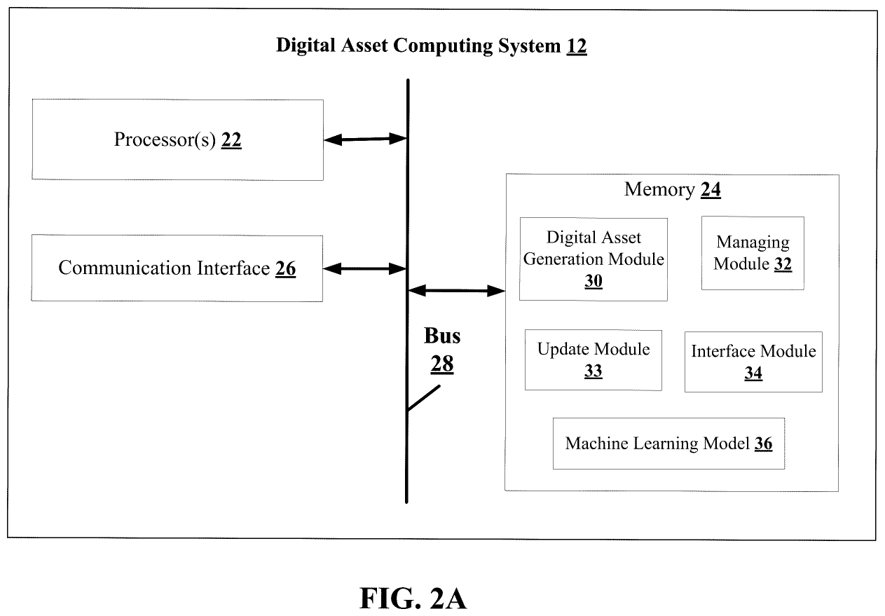

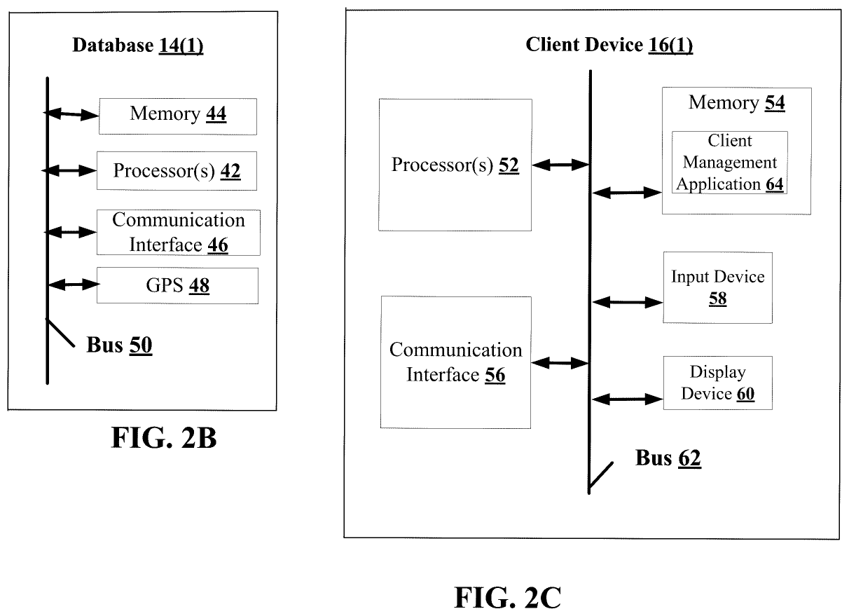

An environment 10 with an exemplary digital asset computing system 12 is shown in FIGS. 1-2A. In this example, the environment 10 includes the digital asset computing system 12, a plurality of databases 14(1)-14(n), a plurality of client devices 16(1)-16(n), and a plurality of servers 18(1)-18(n), although the environment may comprise other types and/or numbers of other systems, devices, components, and/or other elements in other configurations. This technology provides a number of advantages including providing systems, methods, and non-transitory computer readable media that enable the generation and management of digital assets which permit a user to have a comprehensive view of a portfolio which results in better management and decision-making abilities.

Referring to more specifically to FIGS. 1-2A, in this example, the digital asset computing system 12 includes one or more processor(s) 22, a memory 24, and/or a communication interface 26, which are coupled together by a bus or other communication link 28, although the digital asset computing system 12 can include other types and/or numbers of elements in other configurations.

The processor(s) 22 of the digital asset computing system 12 may execute programmed instructions stored in the memory of the digital asset computing system 12 for any number of functions and other operations as illustrated and described by way of the examples herein. The processor(s) 22 of the digital asset computing system 12 may include one or more CPUs or general purpose processors with one or more processing cores, for example, although other types of processor(s) can also be used.

The memory 24 of the digital asset computing system 12 stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s), can be used for the memory 24.

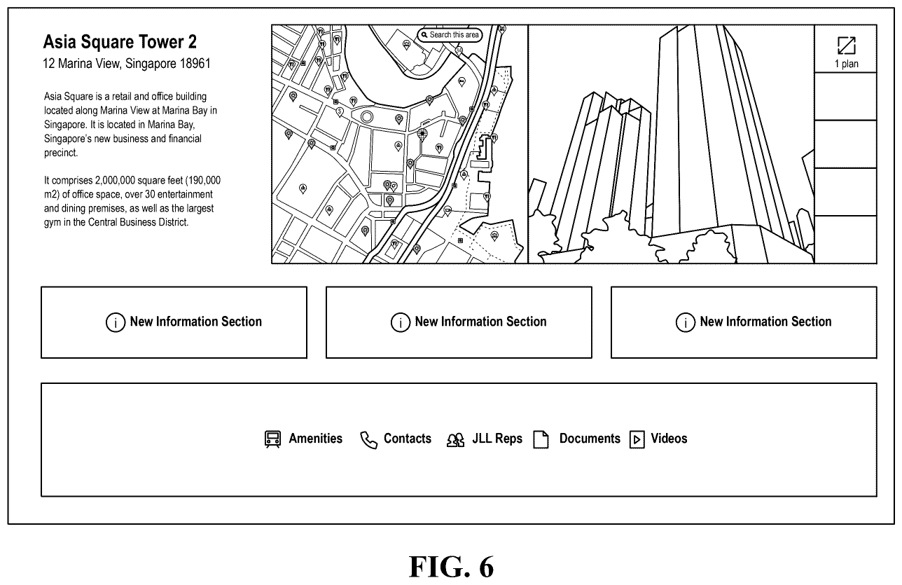

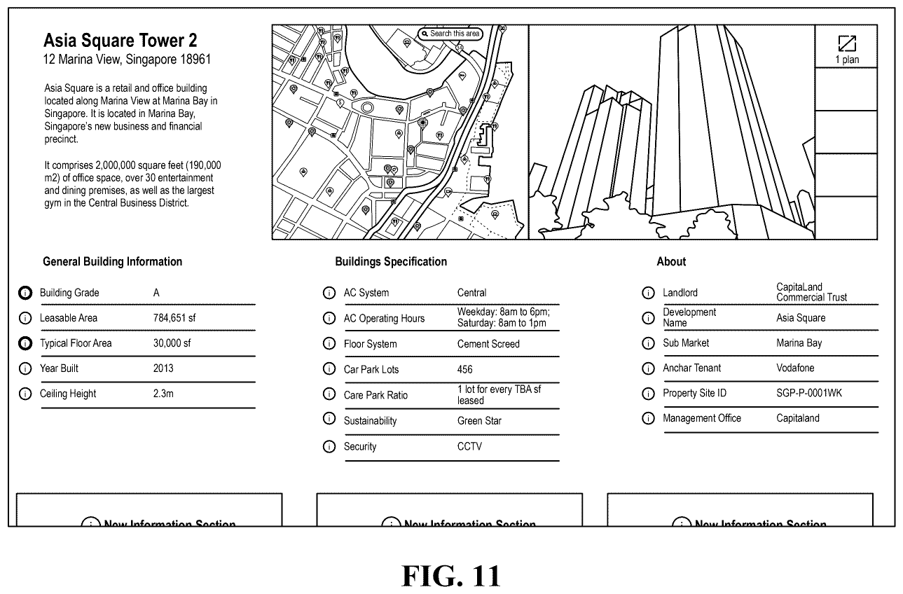

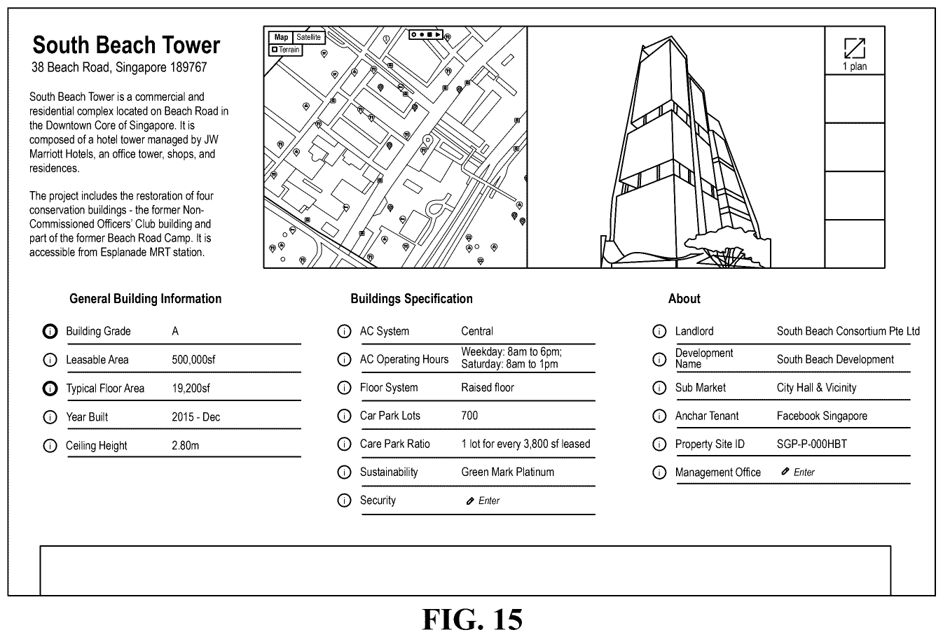

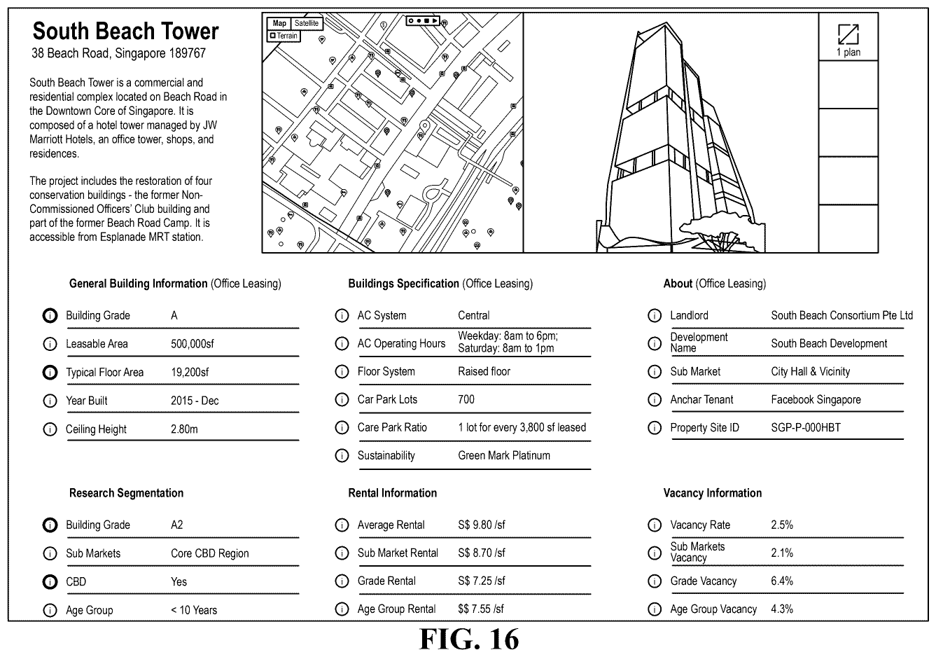

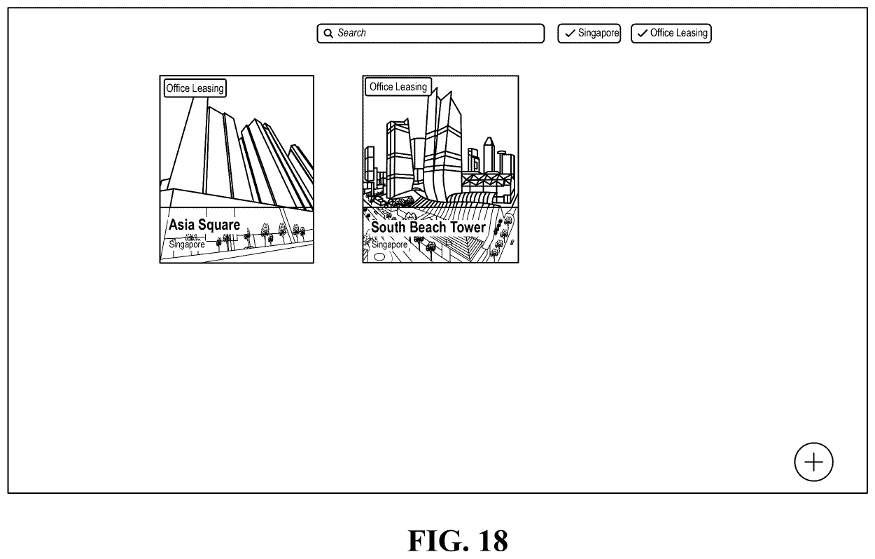

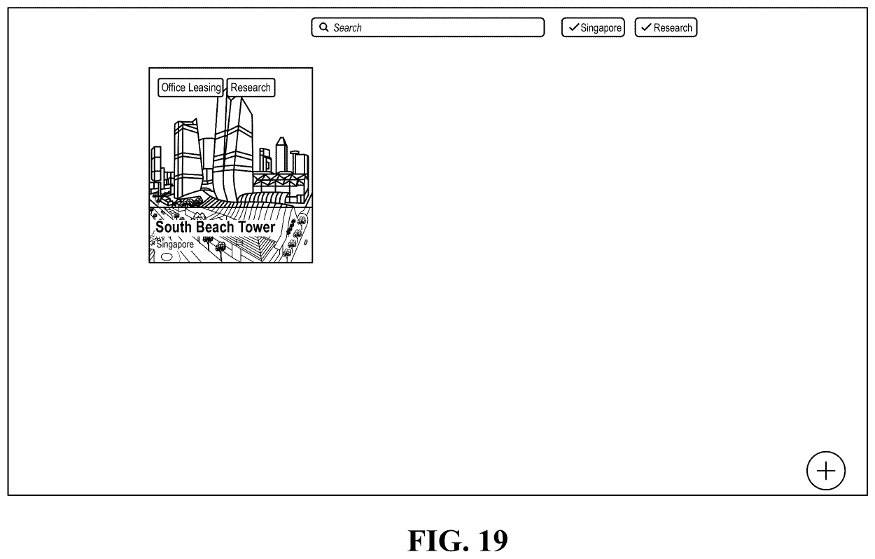

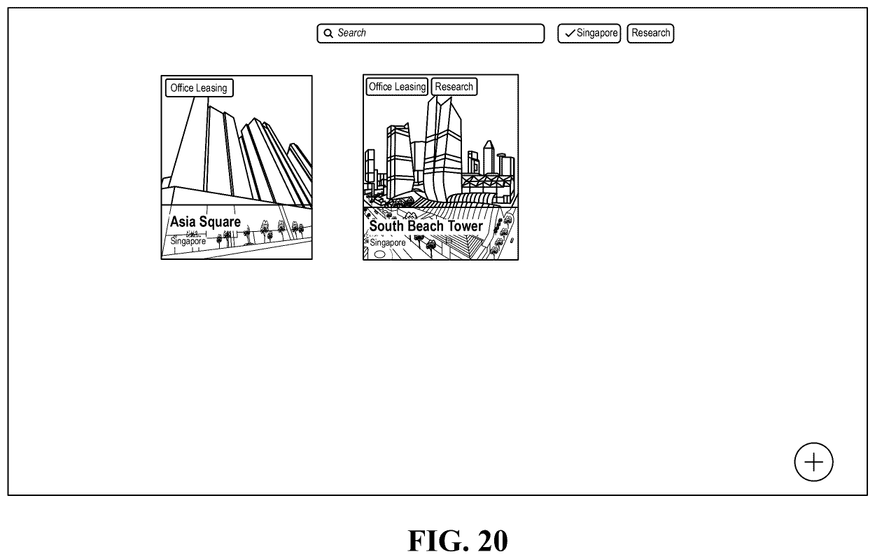

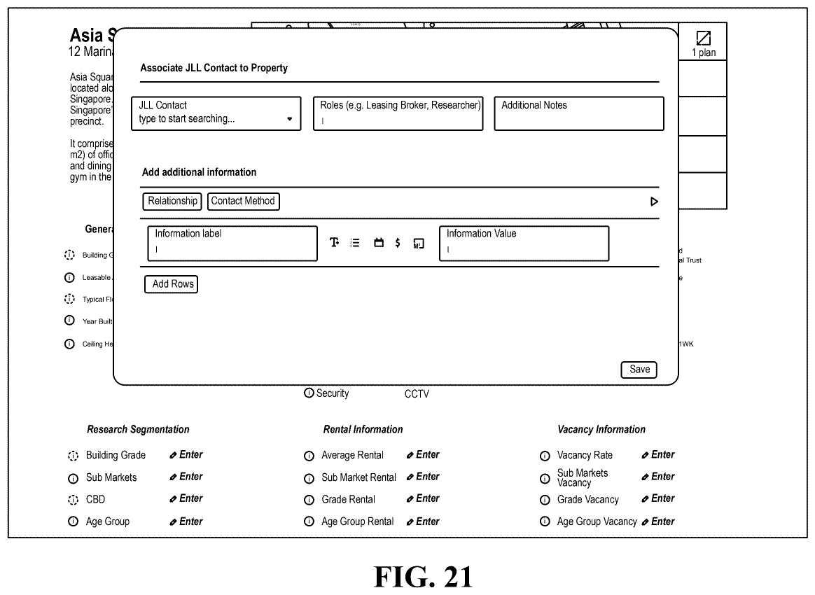

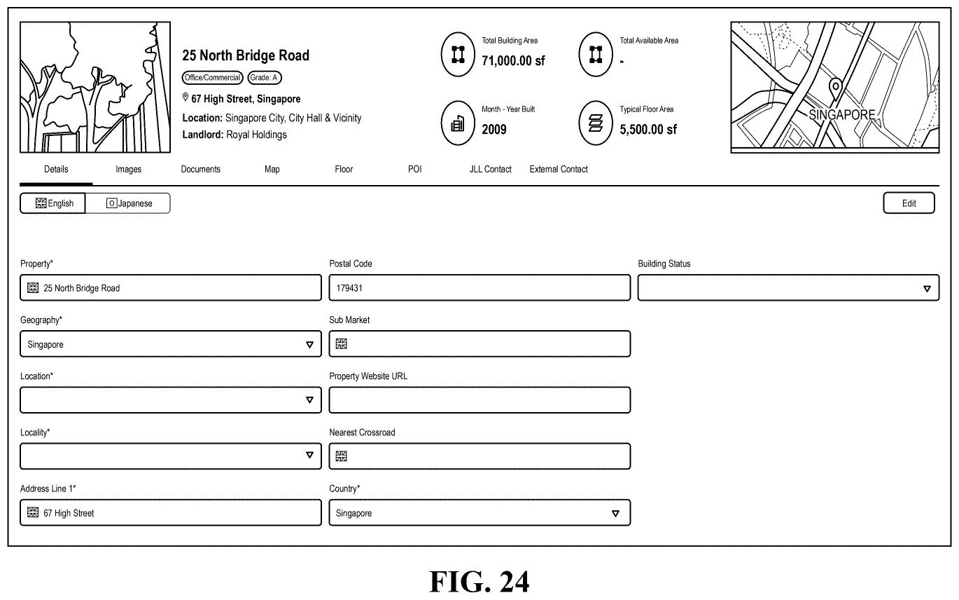

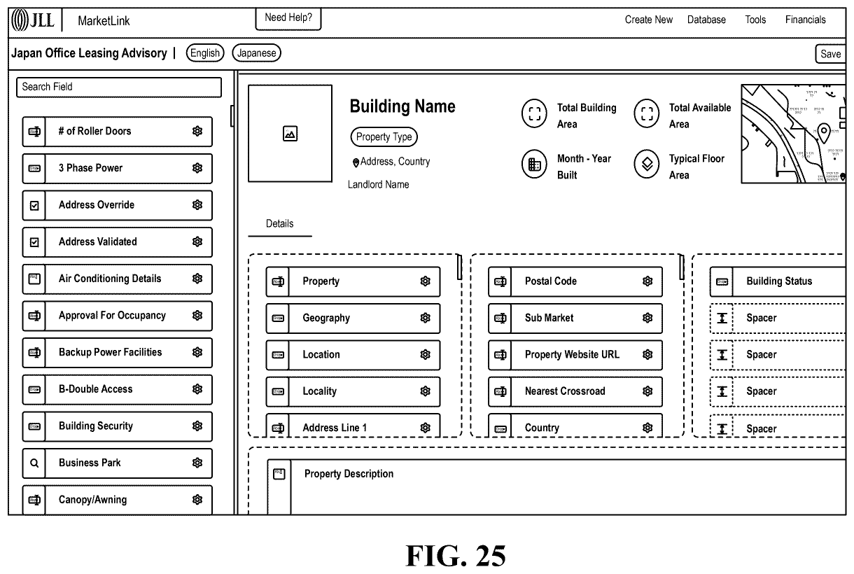

Accordingly, the memory 24 of the digital asset computing system 12 can store one or more applications that can include computer executable instructions that, when executed by the digital asset computing system 12, cause the digital asset computing system 12 to perform actions, such as to generate and manage digital assets stored in one or more databases 14(1)-14(n) with one or more client devices 16(1)-16(n) and one or more servers 18(1)-18(n) in the environment 10, and other actions as described and illustrated in the examples below with reference to FIGS. 1-25. The application(s) can be implemented as modules, programmed instructions, or components of other applications. Further, the application(s) can be implemented as operating system extensions, module, plugins, or the like.

Even further, the application(s) may be operative in a cloud-based computing environment. The application(s) can be executed within or as virtual machine(s) or virtual server(s) that may be managed in a cloud-based computing environment. Also, the application(s), and even the digital asset computing system 12 itself, may be located in virtual server(s) running in a cloud-based computing environment rather than being tied to one or more specific physical computing devices. Also, the application(s) may be running in one or more virtual machines (VMs) executing on the digital asset computing system 12. Additionally, in one or more embodiments of this technology, virtual machine(s) running on the digital asset computing system 12 may be managed or supervised by a hypervisor.

In this particular example, the memory 24 of the digital asset computing system 12 may include a digital asset generation module 30, a managing module 32, an update module 33, an interface module 34, and a machine learning model (MLM) 36 which may be executed as illustrated and described by way of the examples herein, although the memory 24 can for example include other types and/or numbers of modules, platforms, algorithms, programmed instructions, applications, or databases for implementing examples of this technology. In some embodiments, the marketing intel generation module 30, the interface module 32, and/or the MLM 36 can be one unified module that performs the functions of the digital asset generation module 30, the managing module 32, the update module 33, the interface module 34, and/or the MLM 36.

The digital asset generation module 30 may comprise executable instructions that are configured to collect data from any of the databases 14(1)-14(n) or from the client devices 16(1)-16(n) and generate digital assets in a useful and compact format. The digital asset generation module 30 may also comprise executable instructions that are configured to execute other operations and/or functions as illustrated and described in greater detail by way of the examples herein, although this module may have executable instructions that are configured to execute other types and/or functions or other operations to facilitate examples of this technology.

The managing module 32 may comprise executable instructions that are configured to define roles and access controls for the digital assets to facilitate collaboration among various users or departments, as illustrated and described in greater detail by way of the examples herein, although this module may have executable instructions that are configured to execute other types and/or functions or other operations to facilitate examples of this technology, such as authenticating client devices 16(1)-16(n) and filtering data of a digital asset based on a role of a user at a client device at one of the client devices 16(1)-16(n), by way of example.

The interface module 32 may comprise executable instructions that are configured to generate a graphical user interface comprising digital assets, as illustrated and described in greater detail by way of the examples herein, although this module may have executable instructions that are configured to execute other types and/or functions or other operations to facilitate examples of this technology, such as transmitting the graphical user interface to one of the client devices 16(1)-16(n) by way of example.

The update module 33 may comprise executable instructions that are configured to update digital assets stored in the databases 14(1)-14(n) as illustrated and described in greater detail by way of the examples herein, although this module may have executable instructions that are configured to execute other types and/or functions or other operations to facilitate examples of this technology.

The MLM 36 may be a machine learning model 36. In one example, one or more developers may fine-tune a pre-trained MLM 36 with or building data from the digital assets to generate a fine-tuned MLM 36 for specific use cases. Although not illustrated, the plurality of servers 18(1)-18(n) may host and/or manage a plurality of MLMs which may be pre-trained general purpose MLMs or fine-tuned MLMs. The plurality of servers 18(1)-18(n) may be a cloud-based server or an on-premises server. The fine-tuned LLM 36 may be accessed using an application programming interface (API) for use in applications. In another example, the fine-tuned LLM 36 may be hosted by the plurality of servers 18(1)-18(n) and managed remotely by the digital asset computing system 12.

The MLM 36 can be a type of artificial intelligence-machine learning (AI/ML) model that is used to process natural language data for tasks such as natural language processing, text mining, text classification, machine translation, question-answering, response generation, or the like. The MLM 36 uses deep learning or neural networks to learn language features from large amounts of data. The MLM 36 is, for example, trained on a large dataset and then used to generate predictions or generate features from unseen data. The MLM 36 can be used to generate language features such as word embeddings, part-of-speech tags, named entity recognition, sentiment analysis, or the like. Unlike traditional rule-based NLP systems, the MLM 36 does not have to rely on pre-defined rules or templates to generate responses. Instead, the MLM 36 can use a probabilistic approach to language generation, where the MLM 36 can calculate the probability of each word in a response based on the patterns the MLM 36 learned from the training data.

The digital asset computing system 12 may contain programs that train, implement, store, receive, retrieve, and/or transmit one or more machine learning models. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The digital asset computing system 12 may be configured to adjust model parameters during training. Model parameters may include weights, coefficients, offsets, or the like. Training may be supervised or unsupervised.

The digital asset computing system 12 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The digital asset computing system 12 may be configured to optimize statistical models using known optimization techniques.

The digital asset computing system 12 may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may and indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The digital asset computing system 12 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some examples, the digital asset computing system 12 is configured to generate and/or train the MLM 36 to classify a dataset, consistent with disclosed examples.

The digital asset computing system 12 can be configured to generate and/or use the MLM 36 which includes programs (scripts, functions, algorithms) to configure data for visualizations and provide visualizations of datasets and data models. This may include programs to generate graphs and display graphs. The digital asset computing system 12 may include programs to generate histograms, scatter plots, time series, or the like. The digital asset computing system 12 may also be configured to display properties of data models and data model training results including, for example, architecture, loss functions, cross entropy, activation function values, embedding layer structure and/or outputs, convolution results, node outputs, or the like on the one or more of the client devices 16(1)-16(n).

The communication interface 26 of the digital asset computing system 12 operatively couples and communicates between the digital asset computing system 12 and the one or more of databases 14(1)-14(n), the one or more of the client devices 16(1)-16(n), and the one or more servers 18(1)-18(n), although other types and/or numbers of connections and/or communication networks can be used.

While the digital asset computing system 12 is illustrated in this example as including a single device, the digital asset computing system 12 in other examples can include a plurality of devices each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices included in the digital asset computing system 12.

Additionally, one or more of the devices that together comprise the digital asset computing system 12 in other examples can be standalone devices or integrated with one or more other devices or apparatuses, such as in one of the server devices or in one or more computing devices for example. Moreover, one or more of the devices of the digital asset computing system 12 in these examples can be in a same or a different communication network including one or more public, private, or cloud networks, for example.

Although an exemplary digital asset computing system 12 is described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in this digital asset computing system 12, such as the digital asset computing system 12, for example, may be configured to operate as virtual instances on the same physical machine. In other words, by way of example one or more of the digital asset computing system 12 may operate on the same physical device rather than as separate devices communicating through communication network(s). Additionally, there may be more or fewer digital asset computing system 12 than illustrated in FIG. 1.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to conduct steps necessary to implement the methods of the examples of this technology that are described and illustrated herein.

Referring to FIGS. 1 and 2B, the plurality of databases 14(1)-14(n) may comprise a variety of different types and/or numbers of systems, devices, or other things in the environment 10, such as a variety of different marketing data, building data, digital asset data, or combinations thereof by way of example only. In this example, the digital asset computing system 12 has a table, a data structure, or other manner organizing the marketing data, building data, digital asset data, or combinations thereof by way of example, although other manners for categorizing and organizing the data can be used. In this example, each of the databases 14(1)-14(n) at least have the same following structure and operation as shown in the example of the database 14(1) shown in FIG. 2B, although databases 14(1)-14(n) with other types and/or numbers of other systems, devices, components, and/or other elements may be used. Additionally, in this example, the database 14(1) has one or more processors 42, a memory 44, a communication interface, and a global positioning system (GPS) device 48 which are coupled together by a bus or other communication link 50, although each database of data could have other types and/or numbers of systems, devices, components and/or other elements in other configurations.

Referring to FIGS. 1 and 2C, the plurality of client devices 16(1)-16(n) in this example includes any type of computing device that can participate in the generation and management of digital assets in an environment 10 with a client management application 64, such as mobile computing devices, desktop computing devices, laptop computing devices, tablet computing devices, virtual machines (including cloud-based computers), or the like. In this example, each of the client devices 16(1)-16(n) at least have the same following structure and operation as shown in the example of the client device 16(1) shown in FIG. 2C, although client devices with other types and/or numbers of other systems, devices, components, and/or other elements may be used. Additionally in this example, the client device 16(1) includes one or more processor 52, a memory 54, a communication interface 56, an input device 58, and a display device 60, which are coupled together by a bus or other communication link 62, types and/or numbers of systems, devices, components, or other elements in other configurations. Additionally, in this example the memory 54 includes a client management application 64 which enables the client 16(1) to interact with the digital asset computing system 12 and one or more of the databases 14(1)-14(n) as illustrated and described by way of the examples herein, although the memory 54 can include other programmed instructions, modules, applications, or other data for example.

The plurality of servers 18(1)-18(n) in this example includes one or more processors, a memory, and a communication interface, which are coupled together by a bus or other communication link, although other numbers and/or types of network devices could be used. In this example, the servers 18(1)-18(n) can be located at different locations and may each process requests received from the digital asset computing system 12 and/or the client devices 16(1)-16(n) via the communication network(s) 20. Various data and other applications may be operating on the digital asset computing system 12 and transmitting data (e.g., files or Web pages) to the digital asset computing system 12 and/or the client devices 16(1)-16(n). The servers 18(1)-18(n) may be hardware or software or may represent a system with multiple servers in a pool, which may include internal or external networks.

An exemplary method for generating digital assets in the environment 10 with the digital asset computing system 12 and one or more of the client devices 16(1)-16(n) will now be described with reference to FIGS. 1-25.

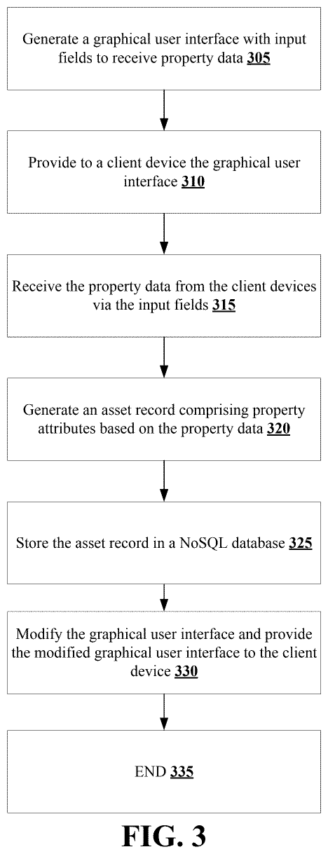

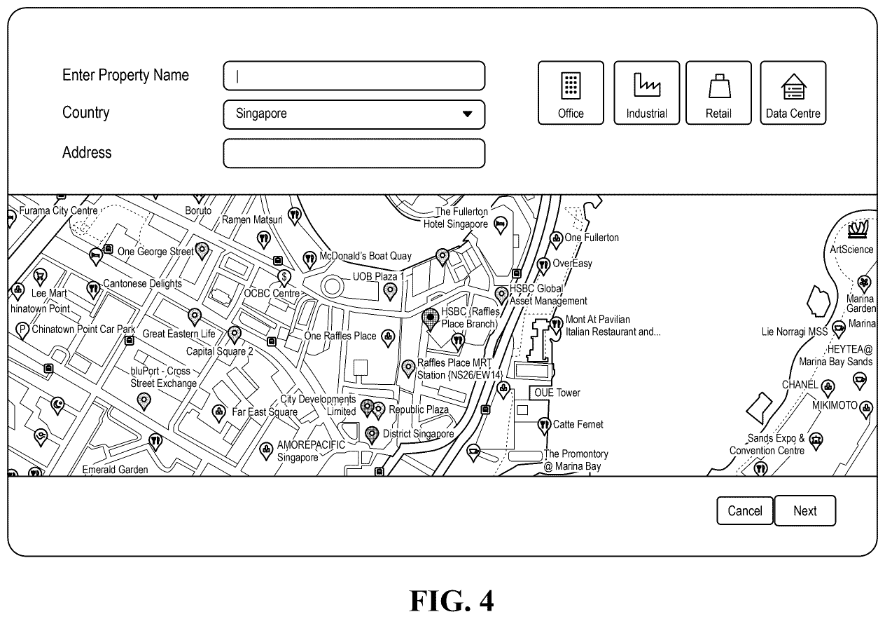

Referring more specifically to FIG. 3, in step 305, the digital asset computing system 12 can generate a graphical user interface with input fields to receive property data related to an asset. Each of the input fields can correspond to a property attribute of the asset. The graphical user interface can be a series of graphical user interfaces that can be designed to be user-friendly, allowing users to easily select property attributes and input relevant information about the property attributes of an asset (e.g., a building), such as location, size, value, and any other pertinent details known in the art as illustrated in FIGS. 4, 5, 10-20, and 24 as explained further below.

### General User Role Vs Power User Role

The digital asset computing system 12 can distinguish between different user roles to ensure appropriate access and provide security and functionality based on the responsibilities and permissions of a user at the client device of one of the client devices 16(1)-16(n). Different user roles can allow the digital asset computing system 12 to restrict the creation of asset records or the schema of the asset records to specific authorized users. In a non-limiting example, there can be two different user roles such as a general user role and a power user role.

A general user role can be assigned to individuals who need to input and manage property data but do not require advanced capabilities (such as the creation of property attributes). General users can access the graphical user interface to enter property data via the input fields related to existing property attributes, such as location, size, and value. In this example, the general user role can input a location of ‘Georgia, USA’ for an asset but cannot change the schema of an asset record to require the input of a location attribute. They can also view and edit the data they have entered, ensuring that the information remains current and accurate. However, general users are restricted from creating new property attributes or modifying the structure for an asset record, maintaining the integrity and consistency of the asset records. This role-based access control ensures that general users can perform their tasks efficiently without compromising the overall security and stability of the asset records.

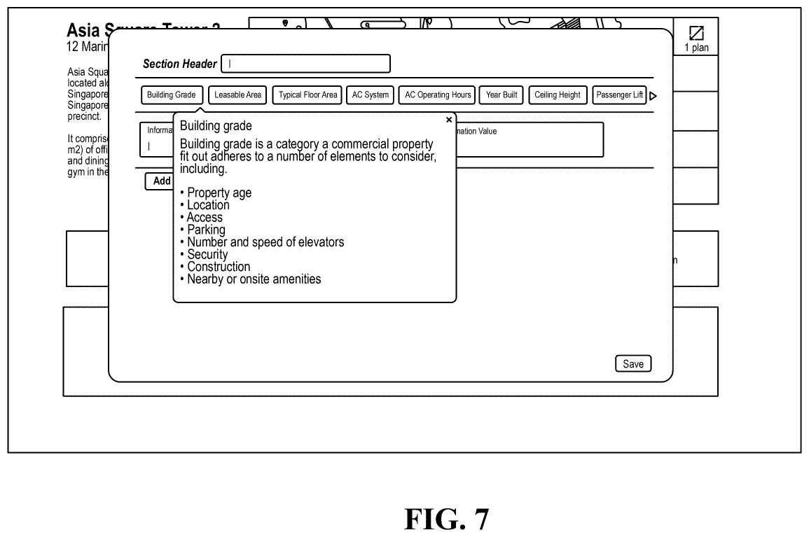

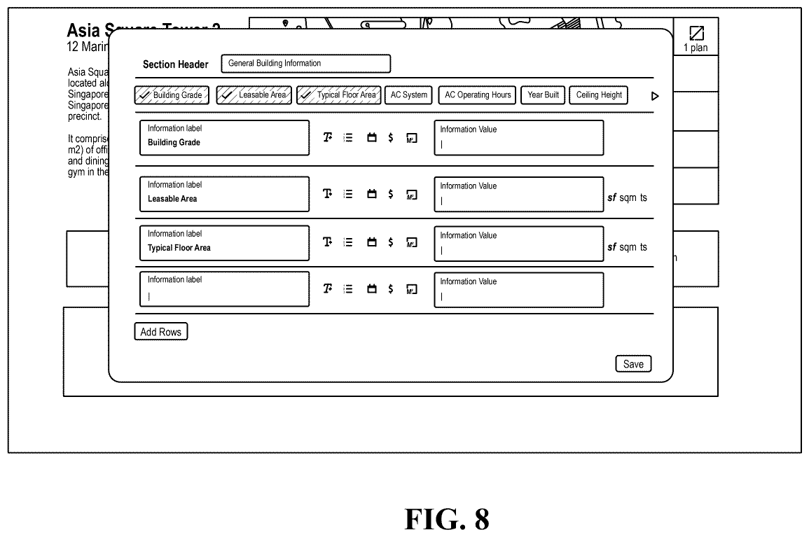

In contrast, a power user role can be granted to individuals with advanced permissions and responsibilities, such as system administrators or senior property managers. Power users can have the ability to create new property attributes, modify existing ones, and configure the digital asset computing system 12 to meet evolving business needs. They can also input property data, similar to general users, but with the added capability of defining custom attributes and section headers. In a non-limiting example, a power user role can access dialog boxes in the graphical user interface illustrated in FIGS. 7 and 8 to create property attributes and section headers (to organize the property attributes) (the creation of property attributes and section headers is outlined further below and not repeated herein for brevity). To ensure security, the digital asset computing system 12 can employ robust authentication mechanisms to verify the identity and role of a user before granting access to these advanced features. This may include multi-factor authentication (MFA), role-based access control (RBAC), and audit logging to track changes made by power users. By differentiating between general and power user roles, the digital asset computing system 12 can ensure that only authorized individuals can make structural changes to the schema of asset records, thereby protecting the integrity and security of the asset records with property data while enabling flexibility and customization where needed.

To verify the identify and role of a user before granting access, the digital asset computing system 12 can determining a role of a user at the client device at one of the client devices 16(1)-16(n) by implementing a multi-step authentication process. The digital asset computing system 12 can verify the user's credentials through a secure login system, which could involve username and password authentication, followed by multi-factor authentication (MFA) to add an additional layer of security. Once the user's identity is confirmed, the digital asset computing system 12 can check the user's role against a predefined role-based access control (RBAC) database at one of the databases 14(1)-14(n) to ascertain their permissions. If the user is identified as a general user, the digital asset computing system 12 can grant access to input and manage the property data within the constraints of their role. Conversely, if the user is identified as a power user, the digital asset computing system 12 can grant access to advanced features as outlined above, such as creating new property attributes and modifying the schema of asset records. This rigorous authentication and role verification process ensures that only authorized users can perform specific actions, thereby maintaining the security, integrity, and consistency of the asset records within the digital asset computing system 12.

### Selecting Property Attributes for an Asset

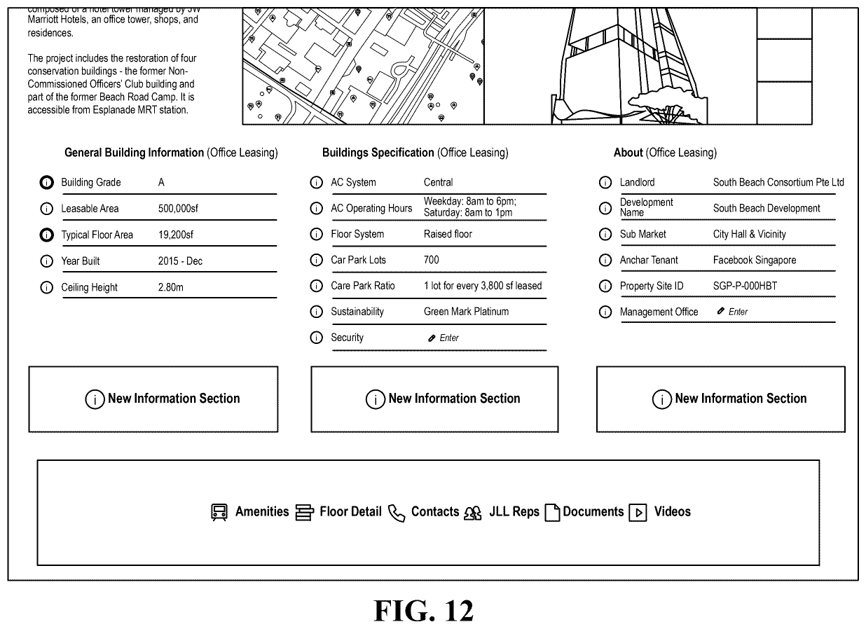

The property attributes can be chosen by a user with a power user role at a client device at one of the client devices 16(1)-16(n). The digital asset computing system 12 can detect first time users and prompt a user with a power user role to start the process outlined in FIG. 3. The digital asset computing system 12 can include information section widgets as illustrated in FIG. 12 to allow the entry of a new information section header or new property attributes.

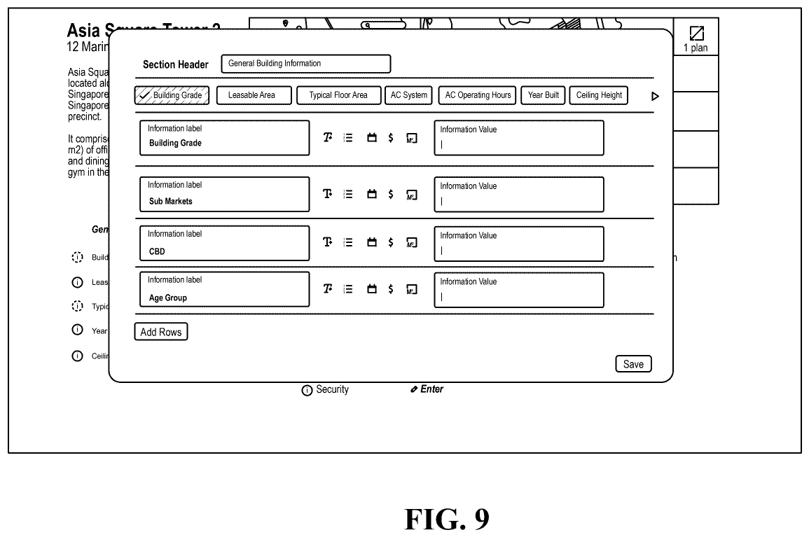

The digital asst computing system 12 can modify the graphical user interface to include suggested property attributes as illustrated in FIGS. 7-9 and 21. The digital asset computing system 12 can use a machine learning model (MLM) 30 to generate the suggested property attributes of the asset. The suggested property attributes can have a data type such as text, number, date, currency, area, other data types known in the art, or combinations thereof. The MLM 30 can generate the suggested property attributes for the asset by analyzing large datasets of existing property attributes and identifying patterns and correlations. By leveraging these insights, the MLM can predict and recommend relevant attributes for a new building based on its characteristics and context. Then the digital asset computing system 23 can receive selected property attributes or custom property attributes from the client device at one of the client devices 16(1)-16(n). The selected property attributes can be suggested property attributes that are selected by the client device at one of the client devices 16(1)-16(n) as illustrated in FIG. 9 (i.e., the building grade). The custom property attributes can be custom attributes created by the client device at one of the client devices 16(1)-16(n) as illustrated in FIG. 9 (i.e., “CBD”, “Sub Markets”, “Age Groups”, etc.). The custom attributes can be configured to have a data type such as text, number, date, currency, area, other data types known in the art, or combinations thereof. The property attributes can comprise the selected property attributes or the custom property attributes. Additionally, the MLM 30 can continuously learn and adapt from the selected property attributes or the custom property attributes from the user to refine and improve the accuracy of the suggested property attributes over time.

In non-limiting examples, the property attributes can be any attributes related to any type of asset. The property attributes can include latitude, longitude, description, owners, building grade, leasable area, typical floor area, year built, ceiling height, air conditioning system, air conditioning operating hours, floor system, car park lots, car park ratio, sustainability, security, landlord, development name, sub market, anchor tenant, property site id, management office, central business district, age groups, average rental price, sub market rental price, grade rental, age group rental, vacancy rate percentage, sub markets vacancy percentage, grade vacancy, age group vacancy, zoning classification, building amenities, energy efficiency rating, public transportation access, tenant mix, building occupancy rate, lease terms, property tax rate, maintenance costs, utility costs, building insurance, tenant improvement allowances, signage opportunities, loading docks, freight elevators, fire safety systems, noise levels, natural light availability, internet connectivity, proximity to major highways, address, building name, property type (which can be standardized by presenting property type options to a user for selection), construction materials, building height, number of floors, architectural style, historical significance, renovation history, earthquake resistance, flood zone status, green building certifications, number of rental tenants, tenant turnover rate, lease renewal rate, tenant satisfaction, rental income, rent collection rate, lease expiration schedule, tenant creditworthiness, rental incentives, furnished vs. unfurnished units, pet policies, parking availability for tenants, tenant screening criteria, rental application process, tenant communication systems, vacancy duration, vacancy advertising costs, vacancy preparation costs, vacancy impact on property value, vacancy impact on neighborhood, vacancy management strategies, owner occupancy rate, owner association fees, owner maintenance responsibilities, owner voting rights, owner meeting schedules, owner dispute resolution processes, owner insurance requirements, owner subletting policies, owner renovation guidelines, owner amenity usage rights, owner financial contributions, owner communication channels, country, country-specific building codes, country-specific tax regulations, country-specific safety standards, country-specific environmental regulations, country-specific energy efficiency standards, country-specific zoning laws, country-specific property market trends, country-specific economic indicators, country-specific political stability, country-specific legal requirements, country-specific cultural considerations, loading capacity, industrial zoning classification, heavy machinery accommodation, power supply capacity, waste disposal systems, hazardous material storage, industrial ventilation systems, proximity to suppliers, proximity to distribution centers, proximity to raw materials, proximity to labor force, industrial noise regulations, industrial safety compliance, industrial waste management, industrial water usage, industrial fire suppression systems, industrial security measures, industrial lighting requirements, industrial floor load capacity, industrial building certifications, other attributes known in the art, or combinations thereof. Each of the property attributes can have field definitions as illustrated in FIG. 7. The digital asset computing system 12 can use the MLM 30 to generate the field definitions for the property attributes or can receive the field definitions from the user at the client device at one of the client devices 16(1)-16(n) to associate to the property attributes.

The digital asset computing system 12 can modify the graphical user interface to include suggested section headers to categorize the property attributes into groups as illustrated in FIGS. 8-16. The digital asset computing system 12 can use a MLM 30 to generate the suggested section headers based on the property attributes of the asset. The MLM 30 can analyze patterns and relationships within the property attributes to create logical and intuitive suggested section headers. Additionally, the MLM 30 can continuously learn and adapt from selected section headers or custom section headers from the user to refine and improve the accuracy of the suggested section headers over time.

The suggested section headers can include general building information, building specification, research segmentation, rental information, vacancy information, about section, owner information, country-specific information, industrial property information, other section headers known in the art, or combinations thereof as illustrated in FIGS. 8-16. In non-limiting examples, a suggested section header can be general building information with property attributes such as latitude, longitude, description, owners, building name, address, property type, construction materials, building height, number of floors, architectural style, historical significance, renovation history, earthquake resistance, flood zone status, and green building certifications. Another suggested section header can be building specifications with property attributes such as building grade, leasable area, typical floor area, year built, ceiling height, air conditioning system, air conditioning operating hours, floor system, car park lots, car park ratio, sustainability, security, landlord, development name, sub market, anchor tenant, property site ID, management office, central business district, building amenities, energy efficiency rating, public transportation access, tenant mix, building occupancy rate, lease terms, property tax rate, maintenance costs, utility costs, building insurance, tenant improvement allowances, signage opportunities, loading docks, freight elevators, fire safety systems, noise levels, natural light availability, internet connectivity, and proximity to major highways. Another suggested section header can be research segmentation with property attributes such as age groups, average rental price, sub market rental price, grade rental, age group rental, vacancy rate percentage, sub markets vacancy percentage, grade vacancy, age group vacancy, and zoning classification. Another suggested section header can be rental information with property attributes such as number of rental tenants, tenant turnover rate, lease renewal rate, tenant satisfaction, rental income, rent collection rate, lease expiration schedule, tenant creditworthiness, rental incentives, furnished vs. unfurnished units, pet policies, parking availability for tenants, tenant screening criteria, rental application process, and tenant communication systems. Another suggested section header can be vacancy information with property attributes such as vacancy duration, vacancy advertising costs, vacancy preparation costs, vacancy impact on property value, vacancy impact on neighborhood, and vacancy management strategies. Another suggested section header can be owner information with property attributes such as owner occupancy rate, owner association fees, owner maintenance responsibilities, owner voting rights, owner meeting schedules, owner dispute resolution processes, owner insurance requirements, owner subletting policies, owner renovation guidelines, owner amenity usage rights, owner financial contributions, and owner communication channels. Another suggested section header can be country-specific information with property attributes such as country, country-specific building codes, country-specific tax regulations, country-specific safety standards, country-specific environmental regulations, country-specific energy efficiency standards, country-specific zoning laws, country-specific property market trends, country-specific economic indicators, country-specific political stability, country-specific legal requirements, and country-specific cultural considerations. Another suggested section header can be industrial property information with property attributes such as loading capacity, industrial zoning classification, heavy machinery accommodation, power supply capacity, waste disposal systems, hazardous material storage, industrial ventilation systems, proximity to suppliers, proximity to distribution centers, proximity to raw materials, proximity to labor force, industrial noise regulations, industrial safety compliance, industrial waste management, industrial water usage, industrial fire suppression systems, industrial security measures, industrial lighting requirements, industrial floor load capacity, and industrial building certifications.

The digital asset computing system 12 can receive selected section headers from among the suggested section headers or custom section headers (created by the user as illustrated in FIGS. 8, 9, 25) from the client device at one of the client devices 16(1)-16(n). The digital asset computing system 12 can then use the MLM 30 to categorize the property attributes into the selected section headers or the custom section headers. The digital asset computing system 12 can also receive data from the client device at one of the client devices 16(1)-16(n) for how the property attributes should be categorized into the selected section headers or the custom section headers.

### Inputting Property Data for Property Attributes

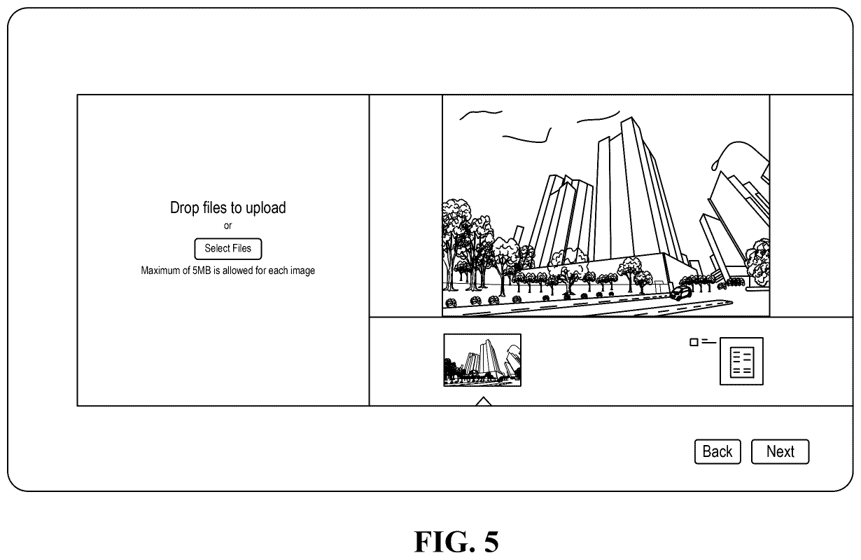

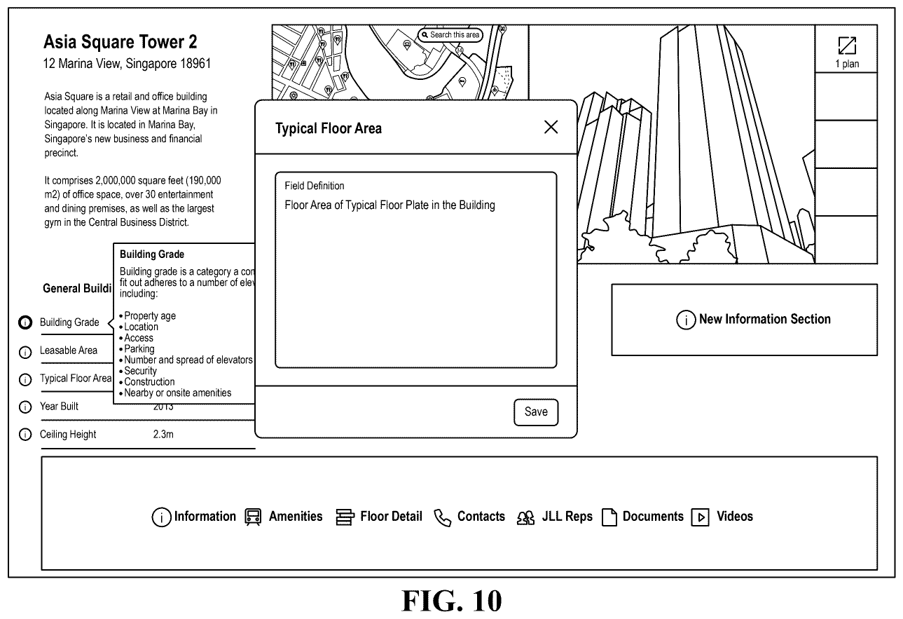

In a non-limiting example, as illustrated in FIG. 4, a graphical user interface can comprise input fields to receive a property name, country, address, and a building type from a user with either a general user role or a power user role. As illustrated in FIG. 4, the graphical user interface can include an interactive map to assist a user at a client device at one of the client devices 16(1)-16(n) in locating the asset. Based on a selection of a location on the interactive map, the digital asset computing system 12 can automatically convert an address into geographic coordinates such as latitude and longitude for additional property attributes of the asset. The building type can include an office, industrial, rental, a data centre, or other building types known in the art. The graphical user interface can also be configured to allow the selection of multiple building types. As illustrated in FIG. 5, the graphical user interface can include a file input drop zone configured to allow the user to drop files of images, floor plans, blueprints, other images of assets known in the art, or combinations thereof of the assets. Additionally, as illustrated in FIGS. 10-16, the graphical user interface can include input fields associated with property attributes (as outlined above) of the asset. The property attributes can differ depending on the type of asset. For example, an office building may have attributes such as the number of floors, total square footage, and available amenities, while an industrial property may include attributes like loading dock availability, ceiling height, and power supply specifications. These input fields ensure that all relevant data is captured accurately, facilitating comprehensive asset management and analysis.

In step 310, the digital asset computing system 12 can provide, to a client device, the graphical user interface. The graphical user interface can be transmitted to the client device to allow the user at one of the client devices 16(1)-16(n) to access and interact with the digital asset computing system 12 remotely. The digital asset computing system 12 can ensure secure data transmission through encryption protocols and user authentication mechanisms. Once the graphical user interface is displayed on the client device, the user can begin entering property data, which is then sent back to the digital asset computing system 12 for processing and storage as outlined below. The digital asset computing system 12 may also provide real-time feedback and validation to the user, ensuring that the data entered meets the required standards and formats. This seamless interaction between the client device and the digital asset computing system 12 enhances user experience and ensures the integrity and accuracy of the property data of the asset collected. In step 315, the digital asset computing system 12 can receive the property data from the client devices via the input fields to associate the property data to the property attributes. Upon receiving the data, the system can perform initial validation checks to ensure that the information is complete and conforms to predefined standards. As various users send the data to the digital asset computing system 12, the system 12 can prevent overwriting of the data between the users as well.

### Asset With Property Attributes

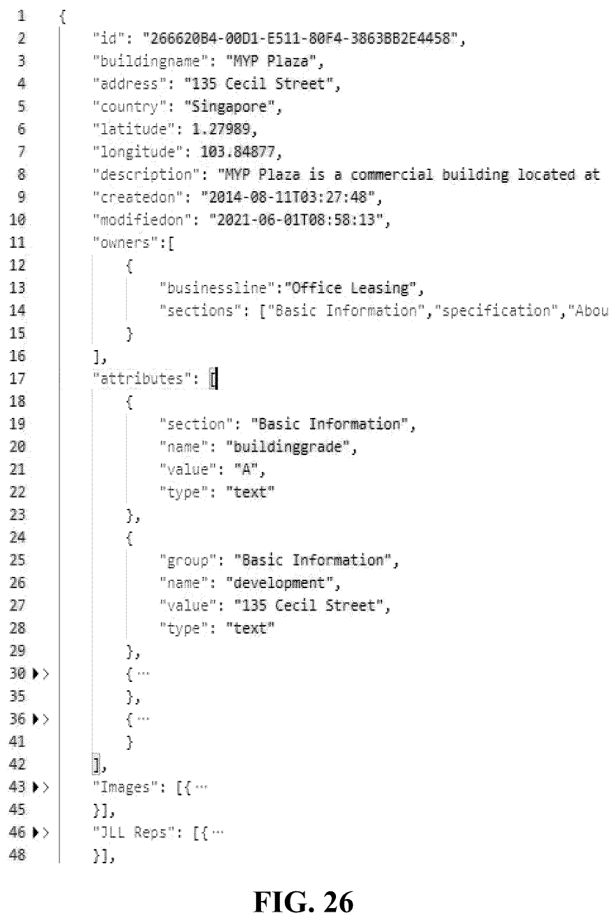

In step 320, the digital asset computing system 12 can generate an asset record comprising property attributes based on the property data received from the client device at one of the client devices 16(1)-16(n) via the input fields as illustrated in a non-limiting example in FIG. 26. The digital asset computing system 12 can generate the asset record using the property data associated with the property attributes. In non-limiting examples, the digital asset computing system 12 can use a structure to map the property attributes to the associated property data. Data structures such as dictionaries, JSON objects containing key-value pairs, XML, YAML, CSV, Avro, Protocol Buffers, relational database tables, and object-oriented programming classes. Each of these structures offers an ability to map the property data to the property attribute in an asset record.

### NOSQL Database and Dynamic Schemas

In step 325, once the asset record is generated, the digital asset computing system 12 can then store the asset record in a NoSQL database at one of the databases 14(1)-14(n). The records in the NoSQL database can have a dynamic schema where a predefined schema is not required for the records in the database at one of the databases 14(1)-14(n). Without a required predefined schema, the asset records can each have different schemas which gives flexibility in the structure of the records. New property attributes can be associated with different asset records without a need to alter an existing schema of an asset record.

The use of a NoSQL database offers several advantages for managing asset records with property attributes of an asset such as a building. One significant advantage is scalability—NoSQL databases can handle large volumes of data and can easily scale horizontally by adding more servers at one of the servers 18(1)-18(n). This is particularly beneficial for companies managing numerous properties with varying attributes. Additionally, NoSQL databases provide high availability and fault tolerance, ensuring that the data remains accessible even in the event of hardware failures. The flexibility of a schema-less design allows for rapid development and iteration, enabling the digital asset computing system 12to adapt quickly to new requirements or changes in the asset records or the property attributes without the need for extensive database restructuring. This adaptability is crucial for accommodating the diverse and evolving needs of different business lines, such as retail, office, and industrial spaces, within a single digital asset management system such as the digital asset computing system 12.

The digital asset computing system 12 can use several types of NoSQL databases, each designed to handle specific types of data and use cases. Document-oriented databases, such as MongoDB and CouchDB, store data in JSON-like documents, making them ideal for applications that require a flexible schema and the ability to store complex data structures. Key-value stores, such as Redis and DynamoDB, use a simple key-value pair model, which is highly efficient for fast lookups and is often used for caching and session management. Column-family stores, like Apache Cassandra and HBase, organize data into columns and rows, similar to relational databases, but with the ability to handle large-scale, distributed data across many servers. This makes them suitable for applications requiring high write and read throughput. Lastly, graph databases, such as Neo4j and Amazon Neptune, are designed to store and query data that is interconnected, making them work for records with connected data (like data connected across asset records).

### Providing Dynamic Schema Collections via GUI

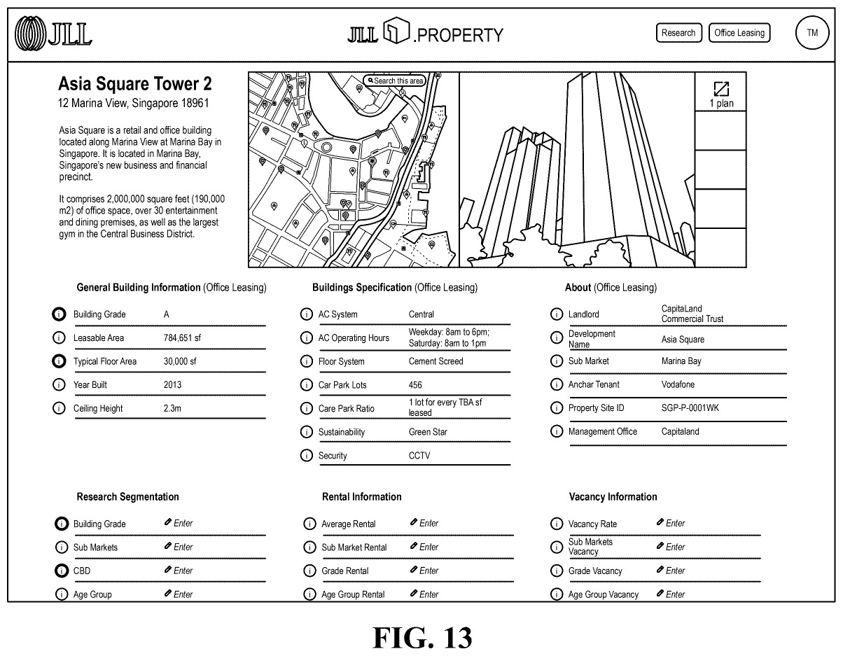

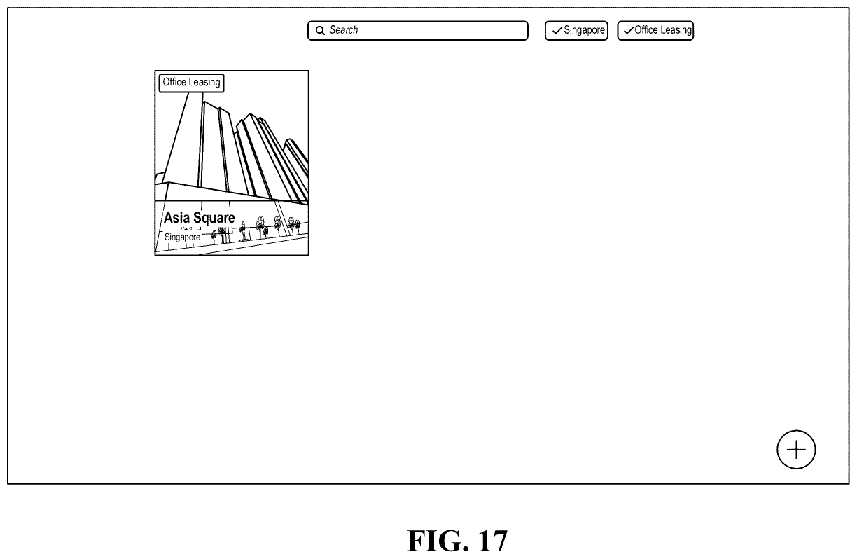

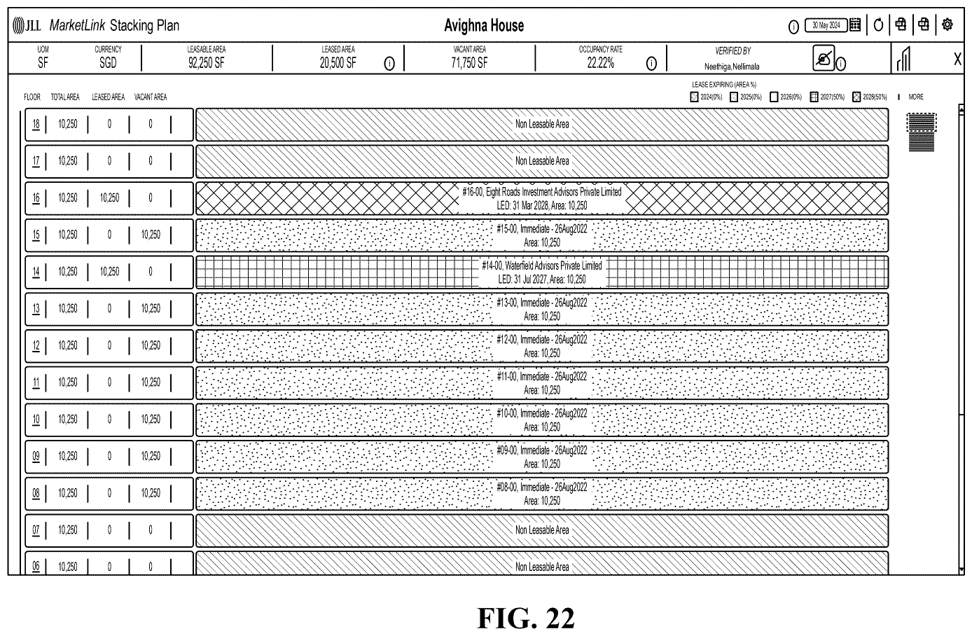

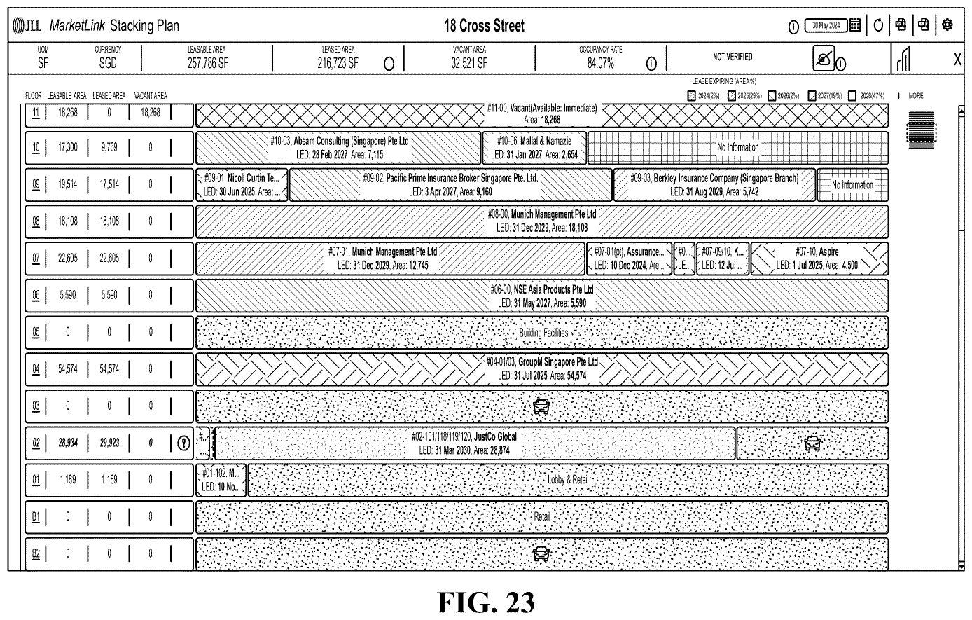

In step 330, the digital asset computing system 12 can then modify the graphical user interface to comprise a set of records from the NoSQL database at one of the databases 14(1)-14(n) and provide the modified graphical user interface to the client device at one of the client devices 16(1)-16(n) as illustrated in FIGS. 17-20. The graphical user interfaces can include any images associated with each of the set of records as illustrated in FIG. 17-20. The digital asset computing system 12 can allow for the selection of one of the set of records for further examination of the property attributes of the selected asset records. Examples of an asset record is illustrated in FIGS. 13-16. The asset record can include a map of the location of the asset, as illustrated in FIG. 13. The asset record can include a break down of an asset based on different floors in the assets as illustrated in FIGS. 22 and 23.

The set of records from the NoSQL database can include all of the asset records stored in the NoSQL database or a subset of the asset records from the NoSQL database. The digital asset computing system 12 can generate the set of records by filtering the asset records stored in the NoSQL database. The digital asset computing system 12 can filter the records based on a location selection, a business line selection, a view selection, a custom search (via a search bar as illustrated in FIGS. 17-20), other filters known in the art, or combinations thereof.

In a non-limiting example, the digital asset computing system 12 can filter the records based on a location selection by identifying asset records that correspond to a selected specific geographic area, such as a city, state, or country. This allows users to quickly access and analyze data relevant to their particular region of interest. In a non-limiting example, a user could filter records to view only properties located in New York City, enabling them to focus on local market trends and property details. Additionally, the digital asset computing system 12 can combine location-based filtering with other criteria, such as property type or business line, to provide a more granular view. For example, a user might filter for office buildings in San Francisco that are certified green buildings, thereby narrowing down the dataset to meet specific business needs. This multi-faceted filtering capability enhances the usability and efficiency of the digital asset computing system 12, allowing users to tailor the data presentation to their unique requirements.

In a non-limiting example, the digital asset computing system 12 can filter the records based on a view selection. There can be two view options such as a business view selection and an enterprise view selection. There can also be additional views known in the art or customized by the user. When the digital asset computing system 12 receives a view selection of a business view, the digital asset computing system 12 can filter the records by allowing users to specify the type of business line they are interested in, such as retail, office, industrial, or hospitality. This enables different departments within a company to access and analyze asset records that is most relevant to their specific operational needs. For instance, a retail leasing team could filter asset records to view only retail spaces within a mixed-use building, while an office leasing team could focus on office spaces. This business view selection ensures that each team can efficiently manage and optimize their respective areas without being overwhelmed by irrelevant data.

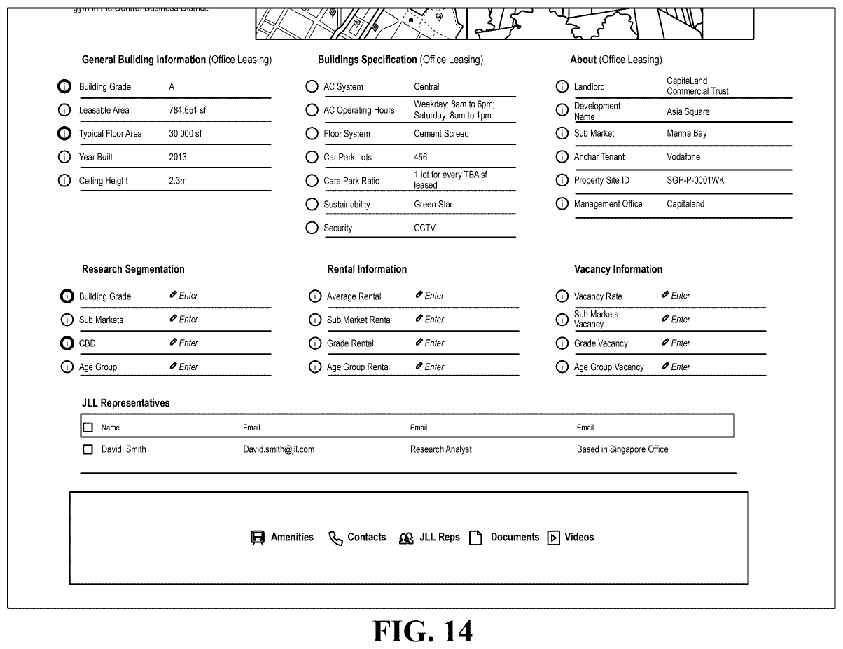

In a non-limiting example, as illustrated in FIG. 14, the digital asset computing system 12 can assign representatives or owners to asset records. The owners can have attributes such as a name, address, email address, job title, location, other attributes known in the art, or combinations thereof. The digital asset computing system 12 can receive owner attributes from the client device at one of the client devices 16(1)-16(n) and associate the owner attributes to the corresponding asset record in the NoSQL database at one of the databases 14(1)-14(n). The digital asset computing system 12 can filter the records based on ownership to create a set of asset records that reflect the interests and responsibilities of different asset record owners. Ownership filtering allows companies to segregate data according to the ownership structure of the assets. For instance, a property management company can filter records to view only those assets owned by a specific investor or ownership group, enabling tailored reporting and analysis for that particular stakeholder. This capability is particularly useful for generating customized financial statements, performance reports, and compliance documentation that meet the specific requirements of each owner. Additionally, ownership-based filtering can help in identifying and managing shared responsibilities, such as maintenance obligations and revenue-sharing agreements, ensuring that all parties have a clear understanding of their roles and contributions. By providing a precise and organized view of asset records based on ownership, the digital asset computing system 12 enhances transparency, accountability, and collaboration among all stakeholders involved in the property management process. Representatives filtering by ownership to see properties they are in charge of can help streamline their workflow by allowing them to focus solely on the assets they manage. This targeted approach reduces the time spent sifting through irrelevant data, enabling representatives to make more informed decisions quickly. Furthermore, it facilitates better communication and reporting with property owners, as representatives can easily access and share pertinent information specific to the properties under their management.

Furthermore, when the digital asset computing system 12 receives a view selection of an enterprise view, the digital asset computing system 12 can filter the asset records by aggregating asset records across multiple business lines and locations (either selected by the user or the MLM 30) to provide a comprehensive overview of the entire property portfolio. This enterprise view can allow senior management and decision-makers to analyze key performance indicators (KPIs) such as overall occupancy rates, total revenue, maintenance costs, and tenant satisfaction scores across all assets. The enterprise view can also allow for the examination of a particular asset record to examine further insights as illustrated in FIGS. 22 and 23. For example as illustrated in FIGS. 22 and 23, the graphical user interface can include a view of the different floors in a building so that a user can examine insights related to businesses in the asset. By using an MLM 30 to consolidate data from various asset records, the digital asset computing system 12 can generate detailed reports and dashboards that highlight trends, identify potential issues, and uncover opportunities for improvement. For example, an enterprise view might reveal that certain properties consistently have higher vacancy rates, prompting further investigation and targeted marketing efforts. Additionally, this holistic perspective enables the users to benchmark performance across different regions and business lines, facilitating more informed strategic planning and resource allocation. The ability to filter and visualize data at an enterprise level ensures that users have the insights needed to drive operational efficiency and maximize the value of the property portfolio. Various view selections can facilitate better decision-making and strategic planning, ultimately enhancing the management and profitability of a property portfolio or collection.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

What is claimed is:

1. A method comprising:
providing, by a computing device to a client device, a graphical user interface with input fields to receive property data, wherein the graphical user interface is generated prior to providing the graphical user interface to the client device;
storing, by the computing device, an asset record in a NoSQL database, wherein the asset record is generated and comprises property attributes based on the property data received from the client device via the input fields, and wherein records in the NoSQL database have a dynamic schema; and
updating and providing, by the computing device, a modified graphical user interface to the client device, wherein the modified graphical user interface comprises a set of records from the NoSQL database.

2. The method as set forth in claim 1, wherein storing the asset record in the NoSQL database further comprises:
determining, by the computing device, a role of a user at the client device, wherein a power user role allows for a modification of the property attributes, and wherein a general user role allow for a modification of the records in the NoSQL database;
in response to determining the role of the user at the client device is the general user role or the power user role, storing, by the computing device, the asset record in a NoSQL database with the property attributes based on the property data; and
in response to determining the role of the user at the client device is not the power user role or the general user role, providing, via the modified graphical user interface, a rejection message to the client device restricting access to records in the NoSQL database.

3. The method as set forth in claim 2, further comprising:
in response to determining the role of the user at the client device is the power user role, modifying, by the computing device, the graphical user interface to comprise suggested property attributes; and
receiving, by the computing device, selected property attributes or custom property attributes from the client device,
wherein the property attributes comprise the selected property attributes or the custom property attributes, and wherein the selected property attributes are selected from the suggested property attributes.

4. The method as set forth in claim 3, wherein the input fields on the graphical user interface each correspond to at least one of the selected property attributes or the customer property attributes, and wherein the asset stored in the NoSQL database comprise of the property attributes associated with the property data received from each of the corresponding input fields.

5. The method as set forth in claim 3, further comprising:
receiving, by the computing device from the client device, a location selection, or a business line selection;
filtering, by the computing device, the set of records from the NoSQL database based on the location selection or the business line selection; and
updating and providing, by the computing device, the modified graphical user interface to the client device, wherein the modified graphical user interface comprises the filtered set of records from the NoSQL database.

6. The method as set forth in claim 3, further comprising:
updating and providing, by the computing device, the modified graphical user interface comprising view options;
filtering, by the computing device, the set of records or the property attributes of the set of records based on a view selection, wherein the view selection is received from the client device and is a business view or an enterprise view; and
updating and providing, by the computing device, the modified graphical user interface to the client device, wherein the modified graphical user interface comprises the filtered set of records or the filtered property attributes.

7. The method as set forth in claim 3, further comprising:
in response to determining the role of the user at the client device is the power user role, modifying, by the computing device, the graphical user interface to comprise suggested section headers for the property attributes; and
receiving, by the computing device, selected section headers or custom section headers from the client device,
wherein the property attributes are categorized into the selected section headers or the custom section headers.

8. The method as set forth in claim 7, wherein the suggested section headers comprise general building information, building specification, research segmentation, rental information, vacancy information, about section, or combinations thereof.

9. The method as set forth in claim 7, wherein the property attributes comprise building grade, leasable area, typical floor area, year built, ceiling height, air conditioning system, air conditioning operating hours, floor system, car park lots, car park ratio, sustainability, security, landlord, development name, sub market, anchor tenant, property site id, management office, central business district, age groups, average rental price, sub market rental price, grade rental, age group rental, vacancy rate percentage, sub markets vacancy percentage, grade vacancy, age group vacancy, zoning classification, building amenities, energy efficiency rating, public transportation access, tenant mix, building occupancy rate, lease terms, property tax rate, maintenance costs, utility costs, building insurance, tenant improvement allowances, signage opportunities, loading docks, freight elevators, fire safety systems, noise levels, natural light availability, internet connectivity, proximity to major highways, address, building name, property type, construction materials, building height, number of floors, architectural style, historical significance, renovation history, earthquake resistance, flood zone status, green building certifications, number of rental tenants, tenant turnover rate, lease renewal rate, tenant satisfaction, rental income, rent collection rate, lease expiration schedule, tenant creditworthiness, rental incentives, furnished vs. unfurnished units, pet policies, parking availability for tenants, tenant screening criteria, rental application process, tenant communication systems, vacancy duration, vacancy advertising costs, vacancy preparation costs, vacancy impact on property value, vacancy impact on neighborhood, vacancy management strategies, owner occupancy rate, owner association fees, owner maintenance responsibilities, owner voting rights, owner meeting schedules, owner dispute resolution processes, owner insurance requirements, owner subletting policies, owner renovation guidelines, owner amenity usage rights, owner financial contributions, owner communication channels, country, country-specific building codes, country-specific tax regulations, country-specific safety standards, country-specific environmental regulations, country-specific energy efficiency standards, country-specific zoning laws, country-specific property market trends, country-specific economic indicators, country-specific political stability, country-specific legal requirements, country-specific cultural considerations, loading capacity, industrial zoning classification, heavy machinery accommodation, power supply capacity, waste disposal systems, hazardous material storage, industrial ventilation systems, proximity to suppliers, proximity to distribution centers, proximity to raw materials, proximity to labor force, industrial noise regulations, industrial safety compliance, industrial waste management, industrial water usage, industrial fire suppression systems, industrial security measures, industrial lighting requirements, industrial floor load capacity, industrial building certifications, or combinations thereof.

10. The method as set forth in claim 7, wherein each of the records in the NoSQL database are associated with one or more owners, and wherein the set of records in the modified graphical user interface is further filtered based on the one or more owners.

11. A digital asset computing system comprising:
one or more processors; and
a memory comprising programmed instructions stored thereon, the one or more processors configured to be capable of executing the stored programmed instructions to:
provide, to a client device, a graphical user interface with input fields to receive property data, wherein the graphical user interface is generated prior to providing the graphical user interface to the client device;
store an asset record in a NoSQL database, wherein the asset record is generated and comprises property attributes based on the property data received from the client device via the input fields, and wherein records in the NoSQL database have a dynamic schema; and
update and provide a modified graphical user interface to the client device, wherein the modified graphical user interface comprises a set of records from the NoSQL database.

12. The system as set forth in claim 11, wherein storing the asset record in the NoSQL database further comprises:
determining a role of a user at the client device, wherein a power user role allows for a modification of the property attributes, and wherein a general user role allow for a modification of the records in the NoSQL database;
in response to determining the role of the user at the client device is the general user role, storing the asset record in a NoSQL database with the property attributes based on the property data; and
in response to determining the role of the user at the client device is not the power user role or the general user role, providing, via the modified graphical user interface, a rejection message to the client device restricting access to records in the NoSQL database.

13. The system as set forth in claim 12, wherein the executable code when executed by the one or more processors further causes the one or more processors to:
in response to determining the role of the user at the client device is the power user role, modify the graphical user interface to comprise suggested property attributes; and
receive selected property attributes or custom property attributes from the client device,
wherein the property attributes comprise the selected property attributes or the custom property attributes, and wherein the selected property attributes are selected from the suggested property attributes.

14. The system as set forth in claim 12, wherein the executable code when executed by the one or more processors further causes the one or more processors to:
in response to determining the role of the user at the client device is the power user role, modify the graphical user interface to comprise suggested section headers for the property attributes; and
receive selected section headers or custom section headers from the client device,
wherein the property attributes are categorized into the selected section headers or the custom section headers.

15. The system as set forth in claim 14, wherein the selected section headers or the custom section headers comprise general building information, building specification, research segmentation, rental information, vacancy information, about section, or combinations thereof.

16. The system as set forth in claim 14, wherein the property attributes comprise building grade, leasable area, typical floor area, year built, ceiling height, air conditioning system, air conditioning operating hours, floor system, car park lots, car park ratio, sustainability, security, landlord, development name, sub market, anchor tenant, property site id, management office, central business district, age groups, average rental price, sub market rental price, grade rental, age group rental, vacancy rate percentage, sub markets vacancy percentage, grade vacancy, age group vacancy, zoning classification, building amenities, energy efficiency rating, public transportation access, tenant mix, building occupancy rate, lease terms, property tax rate, maintenance costs, utility costs, building insurance, tenant improvement allowances, signage opportunities, loading docks, freight elevators, fire safety systems, noise levels, natural light availability, internet connectivity, proximity to major highways, address, building name, property type, construction materials, building height, number of floors, architectural style, historical significance, renovation history, earthquake resistance, flood zone status, green building certifications, number of rental tenants, tenant turnover rate, lease renewal rate, tenant satisfaction, rental income, rent collection rate, lease expiration schedule, tenant creditworthiness, rental incentives, furnished vs. unfurnished units, pet policies, parking availability for tenants, tenant screening criteria, rental application process, tenant communication systems, vacancy duration, vacancy advertising costs, vacancy preparation costs, vacancy impact on property value, vacancy impact on neighborhood, vacancy management strategies, owner occupancy rate, owner association fees, owner maintenance responsibilities, owner voting rights, owner meeting schedules, owner dispute resolution processes, owner insurance requirements, owner subletting policies, owner renovation guidelines, owner amenity usage rights, owner financial contributions, owner communication channels, country, country-specific building codes, country-specific tax regulations, country-specific safety standards, country-specific environmental regulations, country-specific energy efficiency standards, country-specific zoning laws, country-specific property market trends, country-specific economic indicators, country-specific political stability, country-specific legal requirements, country-specific cultural considerations, loading capacity, industrial zoning classification, heavy machinery accommodation, power supply capacity, waste disposal systems, hazardous material storage, industrial ventilation systems, proximity to suppliers, proximity to distribution centers, proximity to raw materials, proximity to labor force, industrial noise regulations, industrial safety compliance, industrial waste management, industrial water usage, industrial fire suppression systems, industrial security measures, industrial lighting requirements, industrial floor load capacity, industrial building certifications, or combinations thereof.

17. A non-transitory computer readable medium having stored thereon instructions comprising executable code which when executed by one or more processors, causes the one or more processors to:
providing, to a client device, a graphical user interface with input fields to receive property data, wherein the graphical user interface is generated prior to providing the graphical user interface to the client device;
storing an asset record in a NoSQL database, wherein the asset record is generated and comprises property attributes based on the property data received from the client device via the input fields, and wherein records in the NoSQL database have a dynamic schema; and
updating and providing a modified graphical user interface to the client device, wherein the modified graphical user interface comprises a set of records from the NoSQL database.

18. The non-transitory computer readable medium as set forth in claim 17, wherein storing the asset record in the NoSQL database further comprises:
determining a role of a user at the client device, wherein a power user role allows for a modification of the property attributes, and wherein a general user role allow for a modification of the records in the NoSQL database;
in response to determining the role of the user at the client device is the general user role or the power user role, storing the asset record in a NoSQL database with the property attributes based on the property data; and
in response to determining the role of the user at the client device is not the power user role or the general user role, providing, via the modified graphical user interface, a rejection message to the client device restricting access to records in the NoSQL database.

19. The non-transitory computer readable medium as set forth in claim 17, wherein the executable code when executed by the one or more processors further causes the one or more processors to:
determine a role of a user at the client device, wherein a power user role allows for a modification of the property attributes, and wherein a general user role allow for a modification of the records in the NoSQL database;
in response to determining the role of the user at the client device is the power user role, modify the graphical user interface to comprise suggested property attributes; and
receive selected property attributes or custom property attributes from the client device,
wherein the property attributes comprise the selected property attributes or the custom property attributes, and wherein the selected property attributes are selected from the suggested property attributes.

20. The non-transitory computer readable medium as set forth in claim 17, wherein the executable code when executed by the one or more processors further causes the one or more processors to:
receive, from the client device, a location selection, a business line selection, a view selection, or combinations thereof;
filter the set of records from the NoSQL database based on the location selection, the business line selection, the view selection, or combinations thereof; and
update and provide the modified graphical user interface to the client device, wherein the modified graphical user interface comprises the filtered set of records from the NoSQL database.
